(19) United States
(12) Patent Application Publication
(10) Pub. No.: US 2004/0065707 A1
(43) Pub. Date: Apr. 8, 2004

(54) Bicycle attachment device

(76) Inventor: Donald C. Haagstad, Napa, CA (US)

Correspondence Address: DONALD C. HAAGSTAD, 133 TYSON CT, NAPA, CA, 94558, US

(21) Appl. No.: 10/264,560

(22) Filed: Oct. 3, 2002

(51) Int. Cl. B62J 9/00; B62J 7/00; B62J 11/00; B60R 9/00; B60R 11/00

(52) U.S. Cl. 224/519; 224/427; 224/924

(57) ABSTRACT

Bicycle Attachment Device with a rigid shaft approximately six inches long and having a diameter that is sized to slidably fit into a standard bicycle seat support tube, the shaft fixedly attached in a perpendicular fashion toward on end of a square cross section rigid tube or bar sized to fit into the inner dimension of a standard square cross section trailer hitch tube, and the square tube having a standard bolt retaining aperture to help secure attachment to a standard matching aperture in the trailer hitch. A preferred embodiment includes the rigid shaft may include a plurality of progressively larger stepped diameters to accommodate the various inside diameters found on common bicycle seat support tubes, the stepped diameters.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of bicycle accessories and more specifically to a bicycle attachment device.

It has been a challenge for people to transport bicycles in or on a vehicle so that they may use the bicycle at a remote location.

Various solutions have been designed and marketed to solve this problem. Most of the solutions involve a rack of some sort that attaches to a vehicle by means of the bumper, or a roof rack or other attachment areas on the outside surface of the vehicle. However there are several serious deficiencies in the prior designs. First, it is usually difficult and time consuming to attach the rack to the vehicle. There are usually multiple straps, brace members and mounting hardware. Second, if the bicycle is not properly attached to the rack, and if the rack is not properly attached to the vehicle, the bicycle may slip or be dislodged. Additionally, the existing bicycle racks can be expensive to manufacture and purchase.

### BRIEF SUMMARY OF THE INVENTION

The primary object of the invention is to provide a bicycle attachment device that allows a person to removably attach a bicycle to a vehicle.

Another object of the invention is to provide a bicycle attachment device that uses the bicycle seat retaining tube as a primary attachment means.

Another object of the invention is to provide a bicycle attachment device that is easy to install.

A further object of the invention is to provide a bicycle attachment device that is economical to manufacture.

Yet another object of the invention is to provide a bicycle attachment device that easily accommodates various styles of bicycles and vehicles.

Still yet another object of the invention is to provide a bicycle attachment device that can be attached to a variety of locations on the vehicle such as a trailer hitch, a roof rack or a bumper.

Another object of the invention is to provide a bicycle attachment device that can carry one or a plurality of bicycles.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed Bicycle Attachment Device comprising: a rigid shaft approximately seven inches long and having a diameter that is sized to slidably fit into a standard bicycle seat support tube, said shaft fixedly attached in a perpendicular fashion toward on end of a square cross section rigid tube or bar sized to fit into the inner dimension of a standard square cross section trailer hitch tube, and said square tube having a standard bolt retaining aperture to help secure attachment to a standard matching aperture in said trailer hitch.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a perspective view of the invention in use.

FIG. 3 is perspective view of an alternate embodiment of the invention

FIG. 4 is a side section view of the invention

FIG. 5 is a side section view of an alternated embodiment of the invention

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

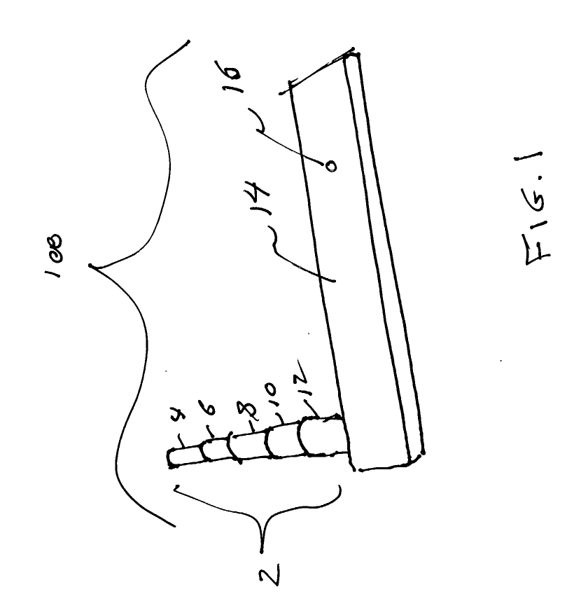

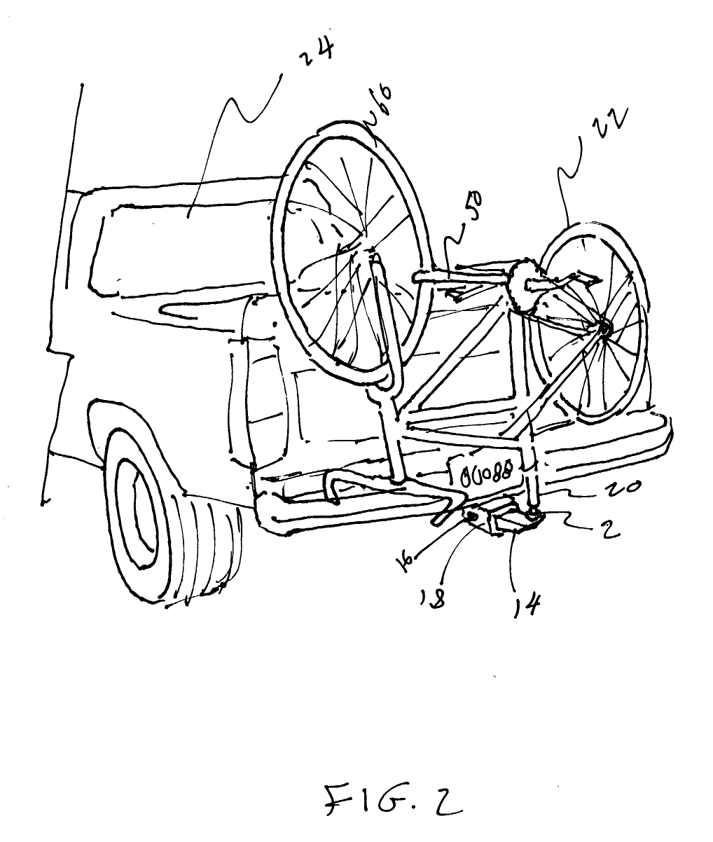

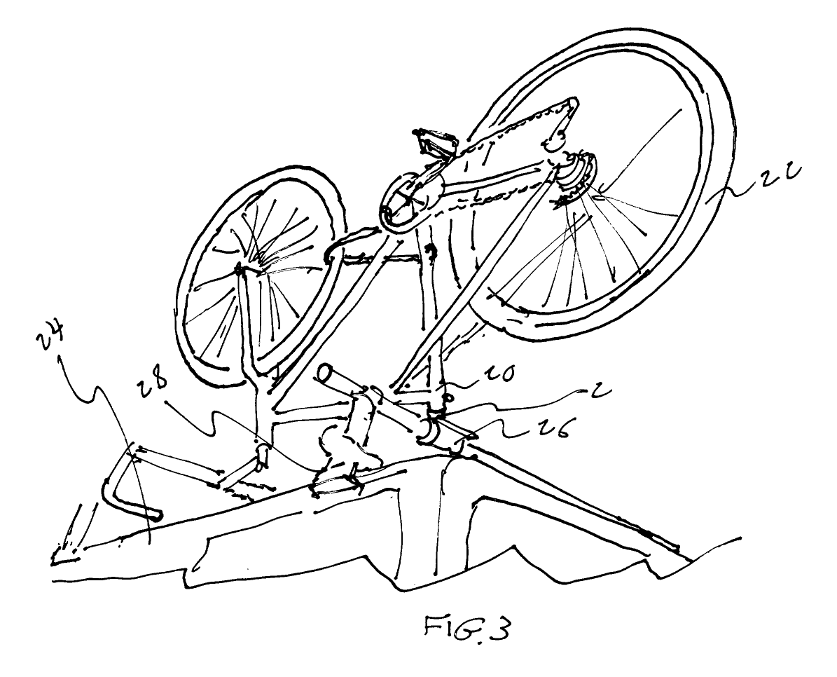

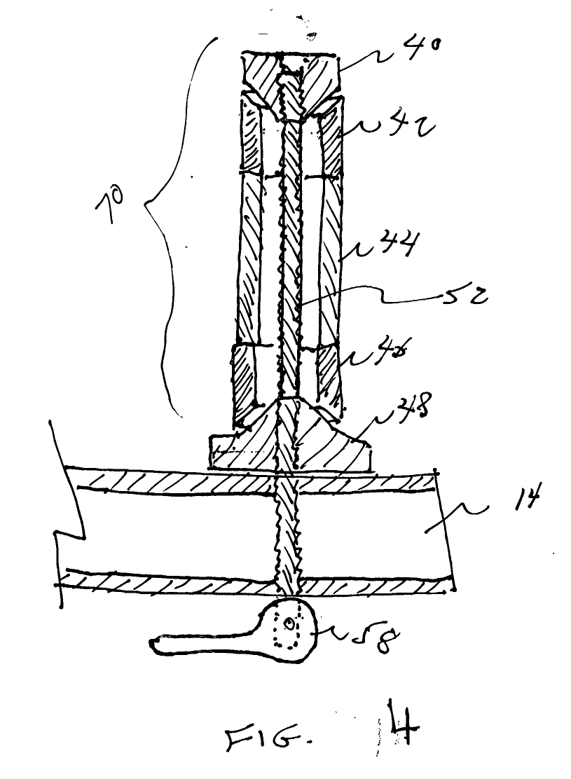

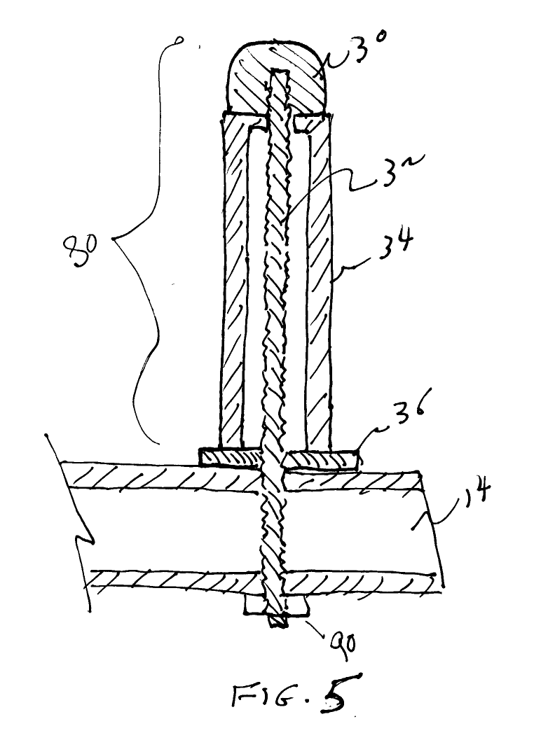

Referring now to FIG. 1 we see a perspective view of the present invention 100. A shaft 2 is fixidly attached in a perpendicular fashion to a square tube or post member 14 that is slightly smaller in cross section than the inside diameter of a standard vehicle trailer hitch tube assembly. Shaft 2 is progressively stepped 4,6, 8, 10, 12 to allow bicycle seat support tubes of various diameters to fit snuggly onto shaft 2. Post 14 has a through hole 16 that corresponds with a similar through hole located in a standard trailer hitch tube assembly. FIG. 2 shows a perspective view of the present invention in use. The perpendicular tube 14 has been inserted into the inside diameter of trailer hitch tube 18. A bolt has been inserted into retaining aperture 16 to retain the perpendicular tube 14 into trailer hitch tube 18. A bicycle 22 has had its seat and seat tube removed so that the seat retaining tube 20 can be slid onto post 2. The seat retaining tube can then be tightened onto the post 2 in the same way a bicycle seat is firmly held in place. A resilient cord 50 is attached at one end to bike wheel 60 and at the other end to a portion of the bike frame to help prevent the front wheel from turning during transport. This unique method of removably retaining a bicycle from a vehicle is extremely simple to install, provides great stability and security, and is very economical to manufacture. Obviously, multiple support posts 2 can be mounted to tube 14 for holding a plurality of bicycles. FIG. 3 is an alternate embodiment of the present invention where support shaft 2 is fixedly attached to a roof rack support bracket 26. In this way, a person can use the unique bike seat support tube holding method in conjunction with a standard roof rack 28 installed on a vehicle 24. FIG. 4 shows an alternate embodiment for the seat support post where the post 70 is comprised of a rigid shaft 44 and a plurality of rubber washers 42 all retained by an upper threaded washer 40, a lower threaded washer 48 and an internal thread rod 52 so that when the user pushes down on standard cam lever 58, threaded rod 52 is drawn in causing rubber washers 42, 46 to expand thereby retaining a bicycle seat support tube regardless of slight changes in diameter. FIG. 5 shows another version of a support shaft where a user can insert a shaft tube of a proper diameter into the assembly and fastening the shaft to tube 14 by means of upper retaining nut 30 and lower retaining nut 90. Washer 36 helps spread the load to post 14. Obviously, the unique bicycle holding method described above can also be adapted to be used as a bicycle holding stand for use during bicycle maintenance and repair.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Bicycle Attachment Device comprising:
a rigid shaft approximately six inches long and having a diameter that is sized to slidably fit into a standard bicycle seat support tube;
said shaft fixedly attached in a perpendicular fashion toward on end of a square cross section rigid tube or bar sized to fit into the inner dimension of a standard square cross section trailer hitch tube; and
said square tube having a standard bolt retaining aperture to help secure attachment to a standard matching aperture in said trailer hitch.

2. Bicycle Attachment Device as claimed in claim 1 wherein said rigid shaft may include a plurality of progressively larger stepped diameters to accommodate the various inside diameters found on common bicycle seat support tubes;
said stepped diameters including—

3. Bicycle Attachment Device as claimed in claim 1 wherein said attachment device may include a plurality of said rigid shafts attached to said square tube so that the said device may carry more than one bicycle.

4. Bicycle Attachment Device as claimed in claim 1 wherein said shaft may include an outer resilient collar and a centrally located aperture housing a slidable rigid post;
said post having a cam lever that, when activated can compress and increase the effective diameter of said resilient collar so that said shaft may snuggly accommodate a variety of diameters of said bicycle seat support tube.

5. Bicycle Attachment Device as claimed in claim 1 wherein said rigid shaft may be removable and replaceable from said square tube with other diameter shafts and attached in standard means to accommodate different sized bicycle seat support tubes.

6. Bicycle Attachment Device as claimed in claim 1 where, in an alternate embodiment, said rigid shaft is fixedly attached to a cross brace;
said cross brace having standard fastening means to attach it to a standard roof rack.

7. Bicycle Attachment Device as claimed in claim 1 further comprising a bungee cord that attaches at one end to the bicycle's handle bar and at the other end to the bicycles frame to prevent the said bicycle's front wheel assembly from turning while said bicycle is in transport.
